(19) United States
(12) Patent Application Publication
(10) Pub. No.: US 2026/0139143 A1
(43) Pub. Date: May 21, 2026

(54) ALKALINE CERIUM-BASED CR/P/F-FREE COATING COMPOSITION FOR METAL SURFACE PRE-TREATMENT

(71) Applicant: Henkel AG & Co. KGaA, Duesseldorf (DE)

(72) Inventors: Yufeng Gu, Shanghai (CN); Hongzong Wang, Shanghai (CN)

(21) Appl. No.: 19/449,155

(22) Filed: Jan. 14, 2026

Related U.S. Application Data
(63) Continuation of application No. PCT/CN2023/108825, filed on Jul. 24, 2023.

(51) Int. Cl. C09D 5/12; C09D 7/61; C09D 7/63; C09D 125/14; C09D 133/02; C09D 135/02; C09D 161/04; C09D 163/00; C23F 11/173

(52) U.S. Cl. CPC C09D 5/12; C09D 7/61; C09D 7/63; C09D 125/14; C09D 133/02; C09D 135/02; C09D 161/04; C09D 163/00; C23F 11/173

(57) ABSTRACT

This invention relates to an alkaline cerium-based coating composition for metal surface pretreatment comprising cerium cation source(s) and at least a water-soluble resin, the water-soluble resin comprising at least a poly(meth)acrylic acid, its derivatives or its copolymer, wherein pH value of the coating composition is 8.0 to 12.0; further relating to a process of producing such alkaline cerium-based coating composition, and to a process of treating a metal substrate based on such an alkaline cerium-based coating composition and its use for the anti-corrosion pretreatment.

### TECHNICAL FIELD

This invention relates an alkaline cerium-based Cr/P/F-free coating composition for metal surface pretreatment, wherein the composition comprises a source of cerium cation and a water-based resin. The present invention also relates the process of producing conversion coating based on such alkaline cerium-based Cr/P/F-free coating composition. The alkaline cerium-based Cr/P/F-free coating composition is environment friendly and stable, in addition, subsequent washing treatment step could be omitted. The conversion coating has good rust resistance, corrosion resistance and coating adhesion.

### BACKGROUND OF THE INVENTION

Chemical conversional coating has usually been considered as an effective method to improve corrosion protection and adhesion to the next layer. A conversion coating is a coating consisting of metallic salts, such as chromate, which form during and after dissolution of a metallic element, or are precipitated from salts onto a substrate. Due to the health risks associated with the application of chromate materials and their disposal, there has been a worldwide research effort to develop alternative coatings which are technically equivalent but do not pose an environmental risk.

Phosphate conversion coating has shown excellent results on steel and galvanized steel and has been widely used in various industries. However, suffered from eutrophication, requiring frequent slag removal, additional sealing steps to reduce porosity and expensive energy inputs, phosphate conversion coating is not an eco-friendly option.

Therefore, the new Cr/P-free conversion coating technology has been widely studied in recent years, such studies provide corrosion resistance comparable to the Cr (vi) system but rely on certain complex fluorides and generally a certain amount of free fluorine, particularly when used to pretreat various metallic materials in the same pretreatment line. However, fluorine is harmful to the environment and health and therefore requires the use of additional occupational safety measures when operating such pretreatment baths.

Over decades, cerium salts have attracted attention as an effective corrosion inhibitor because they are not toxic and are relatively inexpensive. The degree of protection provided to the aluminum strongly depended on the time of immersion in the CeCl₃ solution. To achieve significant protection, a long immersion time was generally required, e.g., at least 100 hours, which makes this process commercially unattractive. The possibility of obtaining a suitable cerium dip coating more quickly by utilizing an oxidizing agent has been explored. The coating exhibits good adhesion to the substrate and to paint films, however, this coating did not perform as well as the films made by the long-term immersion process. Scanning electron microscope characterizations revealed the existence of heavily cracked regions which are considerably greater than the average thickness of the film.

Silane based metal surface pretreatment agent can react on the metal surface to form an intermediary layer which could connect organic and inorganic combinations. Compared with traditional hexavalent chromium passivation treatment agent, the silane metal surface treatment agent does not comprise heavy metal ions, such as Cr⁶⁺, phosphate, or fluoride ions. But long-term storage and/or excess amount of impurity ions will gel the silane solution, especially cations (such as Fe³⁺, Ca²⁺ or Mg²⁺, which is abundant in tap water) have a significant impact on the corrosion resistance of the silane film. Instability of silane-based metal surface pretreatment agent can cause the error of quality of product when the factor (e.g., Ca²⁺ or Mg²⁺ cation in industrial tap water) of production is not steady.

Therefore, there remains a need to develop Cr-free, P-free and F-free alternative coatings which are technically equivalent to traditional thin film conversion coating compositions that are easy to prepare by tap water and maintain safe and stable pre-treatment agent with fewer treatment steps on an industrial pretreatment line. Such an alternative to traditional thin film conversion coating compositions imparts considerable corrosion resistance and paint adhesion to the treated metal substrate.

### SUMMARY OF THE INVENTION

The present invention relates to an alkaline cerium-based coating composition for metal surface pretreatment comprising a) cerium cation source; b) at least a water-soluble resin, the water-soluble resin comprising at least a poly(meth)acrylic acid, poly(meth)acrylic acid derivatives or poly(meth)acrylic acid copolymer, wherein pH value of the coating composition being 8.0 to 12.0.

The present invention relates to a method for producing the coating composition according to present invention, comprising steps of a) mixing the cerium cation source and the water-soluble resin to form a composition; and b) then, adjusting pH value of the coating composition to 8.0 to 12.0.

The present invention also relates to a method for pretreatment of a metal substrate comprising the wet chemical treatment step of contacting the metal substrate with the coating composition of present invention, preferably by spraying and dipping.

The present invention also relates to an article having at least one portion that comprises the treated metal substrate of present invention.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. For example, reference to “an ion” encompasses embodiments having one, two or more ions. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, several terms shall be utilized.

The term “water-soluble” means that the relevant component or ingredient of the composition is miscible in water over an extensive concentration range, e.g., 0-90 wt. % water or more in the total mass of the liquid (vehicle) portion, to form a single phase, binary, aqueous solution. Water-soluble resins are substances that dissolve, disperse, or swell in water and, thus, modify the physical properties of aqueous systems in the form of gelation, thickening, or emulsification/stabilization.

The terms “resin” is used herein consistent with its common usage in chemistry. When mixed in water, these resins generally form dispersions of micelles rather than true solutions. The particles range in size from 0.01 to 0.1 micrometre and produce a clear mixture in the absence of added pigment.

As used herein, the term “cerium cation source” shall mean any cerium-containing compound that, when dissolved in water releases a cerium cation or a counter ion with cerium as a central atom.

Unless otherwise indicated, any amount of a compound that is quantified by “% by weight” in the context of the present invention shall mean the amount in weight percent relative to the corresponding total composition. When quantifying the amount of a compound in a “ppm” manner, the amount refers to parts per million (10⁻⁶) parts by weight.

The property of any of the compositions of the present invention is that alkaline refers to a pH greater than 8.0 and pH refers to the negative logarithm to the base 10.0 of the activity of hydronium ion concentration at 20° C.

Specification of materials in ionic form additionally implies the presence of sufficient counterions to produce electrical neutrality for the composition as a whole (any counterions thus implicitly specified should preferably be selected from among other constituents explicitly specified in ionic form, to the extent possible; otherwise, such counterions may be freely selected, except for avoiding counterions that act adversely to the objects of the invention).

### Compound a) Cerium Cation Source

The cerium cation source in the present invention preferably uses water-soluble cerium (III) and/or cerium (IV) salts. And more preferably the water-soluble salts of cerium (III) and/or cerium (IV) are selected from the group consisting of ammonium cerium (IV) sulfate, ammonium cerium (IV) nitrate, cerium (IV) sulfate, cerium (III) Cerium (III) nitrate, cerium (III) acetate and cerium (III) acetate. Even more preferably, the cerium cation source is selected from cerium (III) salts, and most preferably from cerium (III) carbonate, cerium (III) nitrate and cerium (III) acetate.

As used herein, the term “water soluble” refers to the ability to dissolve more than 5 g/L of cerium salt in deionized water at 20° C. (κ<1 μScm⁻¹) while still maintaining a homogeneous solution for 24 hours without visible precipitates.

The amount of the compound a) in terms of elemental cerium in the basic aqueous coating composition of the present invention is preferably not less than 10 ppm, or not less than 100 ppm, or not less than 150 ppm. When the concentration of the water-soluble salt in the coating composition to be applied to the metal substrate is less than 10 ppm, when the conventional method such as spray coating is applied, the content of the active composition is too small to form a protective coating. On the other hand, the compound a) of the cerium source in the alkaline aqueous coating composition according to the invention preferably does not exceed 20000 ppm, as the coating composition with the higher content of cerium tends to aggregate or form a precipitate. In another preferred embodiment, the aqueous coating composition can be used directly by conventional application methods, and thus the aqueous coating composition contains not more than 4500 ppm, or not more than 3000 ppm, or not more than 2000 ppm, more preferably not more than 1200 ppm, even more preferably not more than 1000 ppm of compound a) in terms of cerium to ensure optimal formation of a thin protective film.

### Compound b) Water-Soluble Resin

The coating composition of the present invention comprises at least one water-soluble resin having a weight-average molecular weight of 500 g/mol to 120,000 g/mol, and the water-soluble resin comprises at least a poly(meth)acrylic acid or its derivatives/its copolymer.

The water-soluble resin further comprises one or more being selected from the group consisting of polyester and its derivatives, polyurethane and its derivatives, phenolic resin and its derivatives, glycoluril resin and its derivatives, epoxy resin. The above water-soluble resins can be used alone or in any combinations.

In some embodiments of the present invention, the concentration of the water-soluble resin in the coating composition is preferably from 10 ppm to 120,000 ppm (0.001 wt. % to 12.0 wt. %), or 10 ppm to 20,000 ppm, or 10 ppm to 10,000 ppm, or 15 ppm to 2000 ppm, or 20 ppm to 1600 ppm. The lower limit concentration of the water-soluble resin in the coating composition is 10 ppm, or 12 ppm, or 15 ppm, or 18 ppm, or 20 ppm, or 80 ppm, or 100 ppm, or 200 ppm, or 400 ppm, or 600 ppm, or 800 ppm. The upper limit concentration of the water-soluble resin is 120,000 ppm, or 80,000 ppm, or 50,000 ppm, or 30,000 ppm, or 20,000 ppm, or 10,000 ppm, or 8000 ppm, or 6000 ppm, or 5000 ppm, or 4000 ppm, or 2000 ppm, or 1800 ppm, or 1600 ppm.

The ratio of component a) to component b) (cerium/resin) influences the anti-corrosion property of the coating composition according to the invention. In some of the embodiments, the mass ratio of the cerium in the cerium cation source to the water-soluble resin (cerium/resin) is from 1:1 to 1:25, or from 1:1 to 1:20, or from 1:1.5 to 1:15, or from 1:2 to 1:10. Preferably, it is preferably in the range of from 1:2 to 1:5. If the mass ratio of the cerium in the cerium cation source to the water-soluble resin (cerium/resin) exceeds 1:1, the cerium cation source will cause the anti-corrosion effect to be saturated and uneconomical, in addition, the composition stability is decreased. On the other hand, if the mass ratio of the cerium in the cerium cation source to the water-soluble resin (cerium/resin) is less than 1:25, the anti-corrosion effect caused by the cerium cation source is not preferable.

The term “poly(meth)acrylic acid” of the present invention refers to polyacrylic acid and/or polymethacrylic acid. The poly(meth)acrylic acid derivatives refer to poly((methyl)acrylic acid), poly(acrylic acid) sodium salt, poly(methacrylic acid) ammonium salt, poly(vinyl acetate), acrylic acid-2-acrylamino-2-methylpropane sulfonic acid copolymer and other acrylic polymer, etc. The poly(meth)acrylic acid and its derivatives have a weight-average molecular weight of 500 g/mol to 120,000 g/mol, or 5,000 g/mol to 100,000 g/mol.

In some of the embodiments, the content of the poly(meth)acrylic acid and its derivatives/its copolymer is 15 wt. % to 100 wt. %, or 20 wt. % to 99 wt. %, or 25 wt. % to 90 wt. %, or 25 wt. % to 85 wt. %, based on the total weight of the water-soluble resin.

Examples of commercially available water-soluble resins are, for example, Acumer 1510 from DOW and NeoRez R-2252 XP from DSM China.

### pH Value of the High Temperature Sealing Solution

The pH value of the coating composition is 8.0 to 12.0, or greater than 8.0 to 12.0, or 8.1 to 12.0, or 8.5 to 12.0, or 9.5 to 11.5, or 9.5 to 11.0, or 10.0 to 11.0. The lower limit of pH value is 8.0, 8.1, or 8.2, or 8.5, or 8.8, or 9.0, or 9.2, or 9.5, or 10.0; the upper limit of pH value is 12.0, or 11.8, or 11.6, or 11.5, or 11.2, or 11.0. One or more optional pH-adjusting agents, including minor amounts of alkali components, which may be used to adjust the pH value to above desired operating pH value if needed.

Examples of the pH adjuster include sodium bicarbonate, potassium carbonate, calcium carbonate, sodium hydroxide, potassium hydroxide, sodium carbonate, ammonia, monoethanolamine, triethanolamine, N-butyl diethanolamine, sodium citrate (disodium citrate, trisodium citrate). Among them, preferred pH adjuster may be the sodium hydroxide, the potassium hydroxide, the ammonia, the monoethanolamine and the triethanolamine. The pH adjusters may be used alone or in the combination of two or more of them. The content of the pH adjuster in the treatment agent is only necessary to be the content with which the pH of the treatment agent may be adjusted to desired operating pH value, e.g., in the range from 8.0 to 12.0.

### Water

The coating composition of the present invention comprises water as solvent to dissolve all components to form the coating composition. In some embodiments of the present invention, it is preferable to use ion-exchange water or pure water or industrial tap water as solvent to prepare coating composition and bath solution therefrom. The amount of the water to be added relative to the total amount of the coating composition (treatment agent) may be 80.000-99.999% by weight, or 88.000-99.999% by weight, or 95.000-99.999% by weight, or 97.000-99.999% by weight, for example, the balance of the treatment agent, excluding the other components.

The coating composition may be supplied as a concentrated concentration, and the concentrated coating composition may be diluted with deionized water or tap water to provide the operating coating composition with a final concentration as above listed preferred concentrations.

### Cr/P/F-Free

The invention is characterized in that corrosion of the metal substrate is substantially prevented by the coating formed by the alkaline aqueous composition, especially when further organic coatings are applied. Thus, the invention does not rely on the formation of a coating consisting essentially of chromates, phosphates, fluoride anions and fluorometallate anions or hydroxides/oxides of the elements Zr, Ti and/or Hf. Therefore, the content of each of the elements Cr, P or F in the alkaline aqueous composition of the present invention is less than 100 ppm, preferably less than 10 ppm, more preferably less than 1 ppm, calculated as elemental Cr, P or F. It is also preferred that each of the elements Zr, Ti or Hf is present in the basic aqueous composition in an amount of less than 50 ppm, more preferably less than 10 ppm and even more preferably less than 5 ppm. That is, the coating composition of present invention has technically equivalent anti-corrosion properties and does not contain any fluorine-containing raw material, or phosphorus containing raw material or chromium-containing raw material.

### Zinc Cation Source

The coating compositions of present invention may further comprise a zinc cation source. The zinc cation source in the present invention preferably includes water-soluble zinc salts. The water-soluble zinc salts are selected from a group consisting of zinc sulfate, zinc nitrate, zinc acetate, zinc borate, zinc citrate, zinc gluconate and zinc carbonate. More preferably, the water-soluble zinc salts include zinc carbonate, zinc nitrate and zinc acetate.

The amount of the water-soluble zinc salts in terms of elemental zinc to be added relative to aqueous coating composition may be 10 ppm to 1000 ppm, or more preferably, 50 ppm to 300 ppm.

### Optional Additives

The coating compositions of the present invention may further comprise optional additives. The selection of suitable additives for the coating composition depends on the specific intended use of the coating composition and can be determined in the individual case by those skilled in the art.

### Preparing Method of the Coating Composition

In some embodiments of the present invention, the coating composition is preferably prepared by steps of:
a) dissolving water-soluble resin which comprises at least a water-soluble polyacrylic acid, poly (acrylic acid) sodium salt, or acrylic acid-2-acrylamino-2-methylpropane sulfonic acid copolymer, having a weight-average molecular weight from 500 g/mol-120,000 g/mol, in water with stirring so as to obtain a solution a);
b) adding water-soluble cerium cation source in the solution a) obtained in step a) with stirring so as to obtain a solution b), and
c) then adjusting the pH value of the solution b) obtained in step b) to achieve a proper pH value of 8.0 to 12.0.

As used herein, “M_{w}” refers to the weight average molecular weight and means the theoretical value as determined by Gel Permeation Chromatography (GPC) relative to linear polystyrene standards of 1.1 M to 580 Da and may be performed using Waters 2695 separation module with a Waters 2414 differential refractometer (RI detector).

In some embodiments of the present invention, the coating composition preferably has a pH from 8.0 to 12.0, or from greater than 8.5 to 12.0, or from 9.5 to 11.5, or from 10.0 to 11.0. Within above range, the higher the pH value of the pretreatment coating composition, the better the anti-corrosion performance.

However, due to the instability of the silane system, the pH value of the silane-containing pretreatment composition generally does not exceed 9.0 or 10.0, otherwise gelation will occur. Bur for present invention, the pH value can exceed 9.5 or exceed 10.0.

It is surprisingly found that water-soluble acrylic resin can form a stable solution system with cerium salt, and the solution will not precipitate when the pH value is increased to 8.0, or 10.0 or even higher. If the pH value of the water-soluble resin solution is adjusted to be alkaline first (for example, pH value is 8.0 or 10.0), the addition of cerium salt will easily lead to precipitation. Then the coating composition is not stable enough for the following treatments.

In some embodiments of the present invention, the coating composition is a clear and uniform solution without delamination or gel.

### Method for Treating a Metal Substrate

A method for treating a metal substrate by using the coating composition according to present invention, comprising:
a) contacting the metal substrate with the coating composition, preferably by spraying or dipping;
b) drying the metal substrate after step a) but before any further coating application and without an intermediate wash step.

By way of non-limiting example, the most commonly metal substrate is cold rolled steel, hot rolled steel, galvanized steel, galvannealed steel, aluminum, and aluminum alloys.

The time slot between step a) and step b) should be no more than 24 hours, in increasing order of preference, 24, 12, 6.0, 5.0, 4.0, 3.0, 2.0, 1.0, 0.50, 0.33, 0.1, or 0.01 hours. The preferred time slot between step a) and step b) should be no more than 20 minutes, 10 minutes, 5 minutes or 1 minute.

The surface of the metal substrate treated according to two treating steps has good corrosion and rust resistance.

### LISTING OF EMBODIMENTS

1. An alkaline cerium-based coating composition for metal surface pretreatment comprising:
   a) cerium cation source;
   b) at least a water-soluble resin, the water-soluble resin comprising at least a poly(meth)acrylic acid, poly(meth)acrylic acid derivatives or poly(meth)acrylic acid copolymer, wherein pH value of the coating composition being 8.0 to 12.0.
2. The coating composition of embodiment 1, wherein the cerium cation source is a water-soluble salt of cerium and/or cerium (IV), preferably a water-soluble salt of cerium.
3. The coating composition of any one of preceding embodiments, wherein the water-soluble salt of cerium and/or cerium (IV) is selected from the group consisting of ammonium cerium (IV) sulfate, ammonium cerium (IV) nitrate, chloride, cerium carbonate, cerium nitrate, cerium acetate and cerium sulfide and preferably selected from the group consisting of cerium nitrate and cerium acetate.
4. The coating composition of any one of preceding embodiments, wherein the content of the cerium cation source in terms of the cerium element is from 10-20000 ppm, preferably 10-4500 ppm, more preferably 15-1800 ppm based on the total weight of the coating composition.
5. The coating composition of any one of preceding embodiments, wherein the water-soluble resin further comprises one or more selected from the group consisting of polyester and its derivatives, polyurethane and its derivatives, phenolic resin and its derivatives, glycoluril resin and its derivatives, epoxy resin.
6. The coating composition of any one of preceding embodiments, wherein the content of the water-soluble resin is from 10-120000 ppm, preferably 15-20000 ppm, more preferably 80-8000 ppm, based on the total weight of the coating composition.
7. The coating composition of any one of preceding embodiments, wherein the content of the poly(meth)acrylic acid, its derivatives and its copolymer is from 15 wt. % to 99 wt. %, preferably 25 wt. % to 85 wt. %, based on the total weight of the water-soluble resin.
8. The coating composition of any one of preceding embodiments, wherein the coating composition contains the respective contents of Cr, P or F of less than 100 ppm, preferably less than 10 ppm and more preferably less than 1 ppm, calculated as elemental Cr, P or F.
9. The coating composition of any one of preceding embodiments, wherein the mass ratio of the cerium in the cerium cation source to the water-soluble resin is from 1:1 to 1:25, preferably from 1:1 to 1:20, more preferably from 1:1 to 1:5.
10. The coating composition of any one of preceding embodiments, wherein the coating composition further comprises a pH adjuster, the pH adjuster comprising one or more selected from sodium hydroxide, potassium hydroxide, ammonia, ammonium bicarbonate, ethanolamine, triethanolamine.
11. The coating composition of any one of preceding embodiments, wherein the pH value of the coating composition is 8.0-12.0 preferably 9.0 to 11.5, more preferably 9.5 to 11.0.
12. A method for producing the coating composition according to any one of embodiments 1 to 11, comprising steps of: a) mixing the cerium cation source and the water-soluble resin to form a composition; and b) then, adjusting pH value of the coating composition to 8.0 to 12.0.
13. A method for pretreatment of a metal substrate comprising the wet chemical treatment step of contacting the metal substrate with the coating composition of any one of embodiments 1 to 11, preferably by spraying and dipping.
14. The method of embodiment 13, wherein the metal substrate is dried after the wet chemical treatment step but before any further coating application and without an intermediate wash step.
15. An article having at least one portion that comprises the treated metal substrate of embodiment 13.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

It should be understood that alternatively, the components listed need not necessarily all be provided by separate chemicals.

Raw Materials

| Product name | Description/function | Source |
|---|---|---|
| Acumer 1510 | Polyacrylic acid resin, Mw = | DOW China |
| | 60000 g/mol, solid content = | |
| | 24-26% | |
| Acumer 1110g | Polyacrylic acid resin, Mw = | DOW China |
| | 4500, solid content = 100% | |
| Acumer 1850 | Polyacrylic acid resin, Mw = | DOW China |
| | 30000, solid content = 29-31% | |
| LJ 58 | Polyacrylic acid resin, Mw = | Shanghai LJ |
| | 120000, solid content = 25%, | Company Ltd. |
| Joncryl 67 | Styrene, acrylic acid copolymer, | BASF China |
| | Mw = 10000, solid content >95% | |
| MA/AA | Maleic anhydride acrylic acid | Shandong |
| | copolymer, Mw = 450-1000, solid | Taihe |
| | content = 48% | Chemicals |
| CP5 | Maleic acid/acrylic acid | BASF China |
| | copolymer, Mw = 70000, solid | |
| | content = 40% | |
| Polyamide 6501 | Polyamide, solid content = 100% | Guangzhou |
| | | Polyee |
| | | Chemicals |
| MODEPICS 508 | epoxy resin, solid content = 33% | Arakawachem |
| TD-1355-HM | phenolic resin | Henkel USA |
| TD-1355-CG | phenolic resin | Henkel USA |
| NeoRez R-2252 XP | Polyurethane, 35.3% resin solids | DSM China |
| | in water | |
| Silane JH A110 S | 3-Aminopropyltriethoxysilane | Jingzhou |
| | | Jianghan Fine |
| | | Chemical |
| Cerium nitrate | AR | Sinopharm |
| hexahydrate | | chemical |
| | | Reagent |
| | | Co., Ltd. |
| Triethanolamine | pH adjuster, AR | Sinopharm |
| (TEA) | | chemical |
| | | Reagent |
| | | Co., Ltd. |
| Potassium | pH adjuster, AR | Sinopharm |
| hydroxide | | chemical |
| | | Reagent |
| | | Co., Ltd. |
| Ammonia | pH adjuster, AR | Sinopharm |
| | | chemical |
| | | Reagent |
| | | Co., Ltd. |
| Monoethanolamine | pH adjuster, AR | Sinopharm |
| (MEA) | | chemical |
| | | Reagent |
| | | Co., Ltd. |
| Sodium | pH adjuster, AR | Sinopharm |
| hydroxide | | chemical |
| | | Reagent |
| | | Co., Ltd. |

□ All raw materials are directly used without any special treatment.

### Example 1

### <Cleaning/Degreasing>

The CRS steel sheet was immersed in a mixture of 3 wt. %0 BONDJERITE C-AK 1022R and 0.3 wt. % BONDJERITE C-AD 1023S diluted with deionized water for 5 minutes at room temperature.

### <Preparation of Alkaline Cerium-Based Coating Composition>

Alkaline cerium-based coating composition was prepared by steps of:
a) All raw materials were directly used without any special treatment. Dissolved 10.00 g of Cerium nitrate hexahydrate (powder, commercially available from Sinopharm chemical Reagent Co., Ltd.) and 80.00 g of Acumer 1510 (liquid, commercially available from Dow, the manufacturer showed Mw=60000 g/mole and solids content=25%) in de-ionized water.
b) added monoethanolamine (liquid, commercially available from Sinopharm chemical Reagent Co., Ltd.) to adjust the pH of the solution from step a) to a pH value of 10.5.
c) Added DI water to form a 1 L solution.
d) Diluted the solution by DI/tap water from step c) to get alkaline cerium-based coating composition described in Example 1.

### <Treating of CRS Steel Sheet>

The CRS steel sheet was treated by steps of:
e) alkaline cerium-based coating composition was applied to the cleaned CRS steel sheet by immersion method in a 2 L plastic beaker for 3 min.
f) CRS Panels were rinsed with deionized water (optional),
g) dried the liquid layer formed in preceding operation to form a treated surface.
h) a powder coating based on a polyester and epoxy blend (EA067Z from Akzo) was electrostatically applied to the CRS plate using a spray gun to produce a 60-80 μm thick coating.
   The treated CRS steel sheet sample was subjected to various tests.

### Example 2-26, and CE1-CE11

The alkaline cerium-based coating composition s of E2 to E26 and CE1 to CE11 were prepared in reference to Example 1. The CRS steel sheet samples of E2 to E26 and CE1 to CE11 were treated in reference to Example 1. More details are listed in below result part.

### Test Methods

### <Neutral Salt Spray Test>

The treated CRS panels were subjected to the Neutral Salt Spray Test (NSST according to ASTM B117-03-2019). The corrosive delamination of the powder coating is assessed by means of maximum creepage at a scribe after 500 h of exposure in the afore-mentioned test.

For the performance test, if the number of 500 h NSST creepages is no more than 2 mm, it is deemed as good (G) while the number of 500 h NSST creepages is no more than 1.5 mm, it is deemed as very good (VG).

### <Impact Test>

The treated CRS panels were also subjected to the Impact Test (according to ISO 6272-2-2011). The panels were tested by 100 kg cm level and observe the impact area for cracks in the coating. If no cracks appear on the coated panel, marked “OK”. Otherwise, marked “NG”.

### <Anti-Flush-Rust Test>

For the anti-flush-rust test, another set of panels was prepared while only the step e) was performed and steps f) to h) of rinse, drying and applying the powder coating are omitted. If there is no visible red rust coming out on the panels within 15 min after step e), then such panel is deemed to show no flash rust. In table 1-4, it is marked as “OK”. Otherwise, it is marked “NG”.

### <Product Stability (DI Water)>

For the product stability test, if the coating composition solution (diluting the solution with DI water) keeps clear without forming visible precipitates within two weeks in both 0° C. and 38° C., then the solution is deemed to be stable. In table 1-4, it is marked “OK”. Otherwise, it is marked “NG”.

### <Product Stability (Tap Water)>

For the product stability test, if the coating composition solution (diluting the solution with tap water) keeps clear without forming visible precipitates within two weeks in both 0° C. and 38° C., then the solution is deemed to be stable. In table 1-4, it is marked “OK”. Otherwise, it is marked “NG”.

### Results

Table 1 shows formulations and properties of the alkaline cerium-based coating compositions E1-E10.

TABLE 1

| | E1 | E2 | E3 | E4 | E5 | E6 | E7 | E8 | E9 | E10 |
|---|---|---|---|---|---|---|---|---|---|---|
| Acumer 1510 | 80 | 80 | 200 | 400 | 800 | 1600 | 4000 | 800 | 800 | 800 |
| (ppm) | | | | | | | | | | |
| Cerium element | 18 | 18 | 180 | 180 | 180 | 180 | 180 | 180 | 180 | 180 |
| (ppm) | | | | | | | | | | |
| pure weight | 1:4.4 | 1:4.4 | 1:1.1 | 1:2.2 | 1:4.4 | 1:8.9 | 1:22.2 | 1:4.4 | 1:4.4 | 1:4.4 |
| ratio | | | | | | | | | | |
| (Ce:Resin) | | | | | | | | | | |
| pH adjuster | MEA | MEA | MEA | MEA | MEA | MEA | MEA | MEA | TEA | NaOH |
| Process | dip- | dip- | dip | dip | dip | dip | Dip | dip | dip | dip |
| | without | without | | | | | | | | |
| | rinse | rinse | | | | | | | | |
| Dipping time | 3 | 1 | 3 | 3 | 3 | 3 | 3 | 3 | 3 | 3 |
| (min) | | | | | | | | | | |
| pH | 10.2 | 10.2 | 10.0 | 10.1 | 9.9 | 9.5 | 8.8 | 9.2 | 8.2 | 11.5 |
| Product stability | OK | OK | OK | OK | OK | OK | OK | OK | OK | OK |
| (DI water) | | | | | | | | | | |
| Product stability | OK | OK | OK | OK | OK | OK | OK | OK | OK | OK |
| (tap water) | | | | | | | | | | |
| Anti-flush- | OK | OK | OK | OK | OK | OK | OK | OK | OK | OK |
| rust test | | | | | | | | | | |
| NSST 500 h | 1.25 VG | 1.80 G | 1.45 VG | 1.50 VG | 1.20 VG | 1.30 VG | 1.35 VG | 1.35 VG | 1.85 G | 1.10 VG |
| Single side | | | | | | | | | | |
| delamination Avg | | | | | | | | | | |
| (mm) | | | | | | | | | | |
| Impact test | OK | OK | OK | OK | OK | OK | OK | OK | OK | OK |
| (after 500 h | | | | | | | | | | |
| NSST | | | | | | | | | | |
| 50/100 kg · cm) | | | | | | | | | | |

Table 2 shows formulations and properties of the alkaline cerium-based coating compositions E11-E19.

TABLE 2

| | E11 | E12 | E13 | E14 | E15 | E16 | E17 | E18 | E19 |
|---|---|---|---|---|---|---|---|---|---|
| Acumer 1110 g (ppm) | 800 | | | | | | | | |
| Acumer 1850 (ppm) | | 960 | | | | | | | |
| LJ 58 (ppm) | | | 800 | | | | | | |
| Joncryl 67 (ppm) | | | | 320 | | | | | |
| MA/AA (ppm) | | | | | 1536 | | | | |
| CP5 (ppm) | | | | | | 1280 | | | |
| Acumer 1510 (ppm) | | | | | | | 80 | 7200 | 20000 |
| Cerium element | 180 | 180 | 180 | 180 | 180 | 180 | 18 | 1800 | 4500 |
| (ppm) | | | | | | | | | |
| pure weight ratio | 1:4.4 | 1:5.3 | 1:4.4 | 1:1.8 | 1:8.5 | 1:7.1 | 1:4.4 | 1:4 | 1:4.4 |
| (Ce:Resin) | | | | | | | | | |
| pH adjuster | MEA | MEA | MEA | MEA | MEA | MEA | MEA | MEA | MEA |
| Process | Dip | dip | dip | dip | dip | Dip | dip | dip | dip |
| Dipping time (min) | 3 | 1 | 3 | 3 | 3 | 3 | 3 | 3 | 3 |
| pH | 10.1 | 10.1 | 9.6 | 10.7 | 9.8 | 10.3 | 9.1 | 10.5 | 10.5 |
| Product stability | OK | OK | OK | OK | OK | OK | OK | OK | OK |
| (DI water) | | | | | | | | | |
| Product stability | OK | OK | OK | OK | OK | OK | OK | OK | OK |
| (tap water) | | | | | | | | | |
| Anti-flush-rust test | OK | OK | OK | OK | OK | OK | OK | OK | OK |
| NSST 500 h | 2.00 G | 2.00 G | 1.90 G | 1.75 G | 1.75 G | 1.55 G | 2.00 G | 1.90 G | 1.63 G |
| Single side | | | | | | | | | |
| delamination | | | | | | | | | |
| Avg(mm) | | | | | | | | | |
| Impact test (after | OK | OK | OK | OK | OK | OK | OK | OK | OK |
| 500 h NSST | | | | | | | | | |
| 50/100 kg · cm) | | | | | | | | | |

Table 3 shows formulations and properties of the alkaline cerium-based coating composition E20-E26.

TABLE 3

| | E20 | E21 | E22 | E23 | E24 | E25 | E26 |
|---|---|---|---|---|---|---|---|
| Acumer 1510 (ppm) | 400 | 400 | 400 | 400 | 200 | | 800 |
| Polyamide 6501(ppm) | 80 | | | | | | |
| MODEPICS 508 (ppm) | | 528 | | | | | |
| TD-1355 HM (ppm) | | | 360 | | 450 | 540 | |
| CP5 (ppm) | | | | 640 | | | |
| LJ 58 (ppm) | | | | | | 200 | |
| Zn element (ppm) | | | | | | | 140 |
| Cerium element (ppm) | 180 | 180 | 180 | 180 | 180 | 180 | 180 |
| pure weight ratio | 1:2.6 | 1:5.1 | 1:4.2 | 1:5.8 | 1:4.1 | 1:4.1 | 1:4.4 |
| (Ce:Resin) | | | | | | | |
| pH adjuster | MEA | MEA | MEA | MEA | MEA | MEA | MEA |
| Process | Dip | dip | dip | dip | Dip | dip | dip |
| Dipping time (min) | 3 | 3 | 3 | 3 | 3 | 3 | 3 |
| pH | 10.3 | 10.0 | 10.3 | 10.3 | 10.2 | 10.3 | 9.9 |
| Product stability | OK | OK | OK | OK | OK | OK | OK |
| (DI water) | | | | | | | |
| Product stability | OK | OK | OK | OK | OK | OK | OK |
| (tap water) | | | | | | | |
| Anti-flush-rust test | OK | OK | OK | OK | OK | OK | OK |
| NSST 500 h | 1.85 G | 2.00 G | 1.70 G | 1.70 G | 1.60 G | 1.80 G | 1.55 G |
| Single side | | | | | | | |
| delamination Avg | | | | | | | |
| (mm) | | | | | | | |
| Impact test | OK | OK | OK | OK | OK | OK | OK |
| (after 500 h NSST | | | | | | | |
| 50/100 kg · cm) | | | | | | | |

Table 4 shows formulations and properties of the comparative coating compositions CE1-CE11.

TABLE 4

| | CE1 | CE2 | CE3 | CE4 | CE5 | CE6 | CE7 | CE8 | CE9 | CE10 | CE11 |
|---|---|---|---|---|---|---|---|---|---|---|---|
| Acumer | 100 | 800 | 800 | 8 | | | | | | 100 | |
| 1510 (ppm) | | | | | | | | | | | |
| Polyamide | | | | | 160 | | | | | | |
| 6501 (ppm) | | | | | | | | | | | |
| MODEPICS | | | | | | 1056 | | | | | |
| 508 (ppm) | | | | | | | | | | | |
| NeoRez | | | | | | | 1130 | | | | |
| R-2252 | | | | | | | | | | | |
| XP (ppm) | | | | | | | | | | | |
| TD-1355- | | | | | | | | 912 | | | |
| CG (ppm) | | | | | | | | | | | |
| TD-1355- | | | | | | | | | 720 | 630 | |
| HM (ppm) | | | | | | | | | | | |
| Silane JH | | | | | | | | | | | 800 |
| A110 S (ppm) | | | | | | | | | | | |
| Cerium | 180 | 180 | 180 | 1.8 | 180 | 180 | 180 | 180 | 180 | 180 | 180 |
| element (ppm) | | | | | | | | | | | |
| pure weight | 1:0.6 | 1:4.4 | 1:4.4 | 1:4.4 | 1:0.9 | 1:5.9 | 1:6.3 | 1:5.1 | 1:4 | 1:4.1 | 1:4.4 |
| ratio | | | | | | | | | | | |
| (Ce:Resin) | | | | | | | | | | | |
| pH adjuster | MEA | MEA | MEA | MEA | MEA | MEA | MEA | MEA | MEA | MEA | MEA |
| Process | dip | dip | dip | dip | dip | dip | dip | Dip | dip | dip | dip |
| Dipping | NA | NA | NA | 3 | NA | NA | NA | NA | NA | NA | NA |
| time (min) | | | | | | | | | | | |
| pH | 10.1 | 5.1 | 7.5 | 8.3 | 9.8 | 9.9 | 9.8 | 10.0 | 10.0 | 10.8 | 10.5 |
| Product | NG | NG | NG | OK | NG | NG | NG | NG | NG | NG | NG |
| stability | | | | | | | | | | | |
| (DI water) | | | | | | | | | | | |
| Product | NG | NG | NG | OK | NG | NG | NG | NG | NG | NG | NG |
| stability | | | | | | | | | | | |
| (tap water) | | | | | | | | | | | |
| Anti-flush- | NA | NA | NA | NG | NA | NA | NA | NA | NA | NA | NA |
| rust test | | | | | | | | | | | |
| NSST 500 h | NA | NA | NA | 1.85 | NA | NA | NA | NA | NA | NA | NA |
| Single side | | | | | | | | | | | |
| delamination | | | | | | | | | | | |
| Avg (mm) | | | | | | | | | | | |
| Impact test | NA | NA | NA | OK | NA | NA | NA | NA | NA | NA | NA |
| after 500 h | | | | | | | | | | | |
| NSST | | | | | | | | | | | |
| 50/100 kg · cm | | | | | | | | | | | |

In Examples 1 to 26, the coating compositions were prepared according to the formulations of alkaline cerium-based coating compositions provided by the present invention. These formulations especially included a cerium cation source and at least a water-soluble resin, the water-soluble resin comprising at least a poly(meth)acrylic acid, poly(meth)acrylic acid derivatives or poly(meth)acrylic acid copolymer, and pH value of the coating compositions being 8.0 to 12.0. It can be seen that when the contents of the claimed components of the present invention are within certain ranges, they can act synergistically, such that the prepared coating compositions have technically equivalent anti-corrosion property & paint adhesion property and do not contain any fluorine-containing raw material, or phosphorus containing raw material or chromium-containing raw material. Meanwhile, the coating compositions have long-term storage-ability, and the coating compositions are easy to prepare by tap water and maintain safe and stable pre-treatment agent with fewer treatment steps on an industrial pretreatment line.

In Comparative examples 5 to 9, the coating compositions were prepared by a comparative water-soluble resin. The prepared coating compositions don't have desired storage-ability and can't be prepared by tap water.

What is claimed is:

1. An alkaline cerium-based coating composition for metal surface pretreatment comprising:
a) cerium cation source;
b) at least a water-soluble resin, the water-soluble resin comprising at least a poly(meth)acrylic acid, poly(meth)acrylic acid derivatives or poly(meth)acrylic acid copolymer,
wherein pH value of the coating composition being 8.0 to 12.0.

2. The coating composition of claim 1, wherein the cerium cation source is a water-soluble salt of cerium and/or cerium (IV).

3. The coating composition of claim 2, wherein the water-soluble salt of cerium and/or cerium (IV) is selected from the group consisting of ammonium cerium (IV) sulfate, ammonium cerium (IV) nitrate, chloride, cerium carbonate, cerium nitrate, cerium acetate and cerium sulfide.

4. The coating composition of claim 1, wherein the content of the cerium cation source in terms of the cerium element is from 10-20000 ppm, based on total weight of the coating composition.

5. The coating composition of claim 1, wherein the water-soluble resin further comprises one or more selected from the group consisting of polyester and its derivatives, polyurethane and its derivatives, phenolic resin and its derivatives, glycoluril resin and its derivatives, epoxy resin.

6. The coating composition of claim 1, wherein the content of the water-soluble resin is from 10-120000 ppm, based on total weight of the coating composition.

7. The coating composition of claim 1, wherein the content of the poly(meth)acrylic acid, its derivatives and its copolymer is from 15 wt. % to 99 wt. %, based on total weight of the water-soluble resin.

8. The coating composition of claim 1, wherein the coating composition contains the respective contents of Cr, P or F of less than 100 ppm, calculated as elemental Cr, P or F.

9. The coating composition of claim 1, wherein the mass ratio of the cerium in the cerium cation source to the water-soluble resin is from 1:1 to 1:25.

10. The coating composition of claim 1, wherein the coating composition further comprises a pH adjuster, the pH adjuster comprising one or more selected from sodium hydroxide, potassium hydroxide, ammonia, ammonium bicarbonate, ethanolamine, and triethanolamine.

11. The coating composition of claim 10, wherein the pH value of the coating composition is 9.0 to 11.5.

12. The coating composition of claim 1, wherein the cerium cation source is a water-soluble salt of cerium present in an amount of 10-4500 ppm measured as cerium element; wherein the water-soluble resin is present in an amount of 15-20000 ppm; each based on total weight of the coating composition.

13. The coating composition of claim 12, wherein the mass ratio of the cerium in the cerium cation source to the water-soluble resin is from 1:1 to 1:20.

14. The coating composition of claim 12, wherein content of the poly(meth)acrylic acid, its derivatives and its copolymer is from 25 wt. % to 85 wt. %, based on the total weight of the water-soluble resin.

15. The coating composition of claim 14, wherein the coating composition further comprises a pH adjuster, the pH adjuster comprising one or more selected from sodium hydroxide, potassium hydroxide, ammonia, ammonium bicarbonate, ethanolamine, triethanolamine.

16. The coating composition of claim 15, wherein the pH value of the coating composition is 9.5 to 11.0.

17. A method for producing the coating composition according to claim 1, comprising steps of:
a) mixing the cerium cation source and the water-soluble resin to form a composition; and
b) then, adjusting pH value of the coating composition to 8.0 to 12.0.

18. A method for pretreatment of a metal substrate comprising a wet chemical treatment step of contacting the metal substrate with the coating composition of claim 1, thereby producing a treated metal substrate.

19. The method of claim 18, wherein the metal substrate is dried after the wet chemical treatment step but before any further coating application and without an intermediate wash step.

20. An article having at least one portion that comprises the treated metal substrate of claim 18.
